(19) United States
(12) Patent Application Publication
(10) Pub. No.: US 2014/0064884 A1
(43) Pub. Date: Mar. 6, 2014

(54) Oven and Adjustable Baking System

(71) Applicants: Guangqian Yang, Shenzhen (CN); Kisun Kang, Shenzhen (CN); Tsungwen Chen, Shenzhen (CN); Chunming Wu, Shenzhen (CN); Wei Li, Shenzhen (CN)

(72) Inventors: Guangqian Yang, Shenzhen (CN); Kisun Kang, Shenzhen (CN); Tsungwen Chen, Shenzhen (CN); Chunming Wu, Shenzhen (CN); Wei Li, Shenzhen (CN)

(73) Assignee: SHENZHEN CHINA STAR OPTOELECTRONIC TECHNOLOGY CO., LTD., Shenzhen ,Guangdong (CN)

(21) Appl. No.: 13/697,357

(22) PCT Filed: Sep. 12, 2012
(86) PCT No.: PCT/CN2012/081289

§ 371 Date: Nov. 11, 2012

(30) Foreign Application Priority Data
Sep. 6, 2012 (CN) CN 201210326813.0

(51) Int. Cl. C03B 35/14; B65G 43/00

(52) U.S. Cl. CPC C03B 35/14; B65G 43/00
USPC 414/148; 700/213; 432/32

(57) ABSTRACT

An oven and an adjustable baking system are proposed. The oven includes a signal receiving module, a baking module, a detecting module, and a feedback module. The signal receiving module is used for receiving a ready-to-send signal sent by a developing apparatus in a previous process from the oven. The ready-to-send signal conveys information of preparing for transferring a glass substrate to the oven. The detecting module is used for detecting the robot to see if the robot takes the glass substrate out of the baking module. The feedback module is used for determining if a confirmation signal is sent back to the developing apparatus according to the detecting result from the detecting module. The confirmation signal conveys information that the developing apparatus should transfer the glass substrate to the feedback module. Because the transferring speed of a glass substrate transferred by the developing apparatus can be adjusted in the oven and the adjustable baking system of the present invention, no buffers are required, reducing equipment costs. In addition, the baking time of the oven is adjusted, which increases efficiency of baking

### CROSS-REFERENCE TO RELATED APPLICATION

This application claims priority from and the benefit under 35 U.S.C. 119(a) of Chinese Patent Application No. 201210326813.0, filed on Sep. 6, 2012, which is hereby incorporated by reference for all purposes as if fully set forth herein.

1. Field of the Invention

The present invention relates to production of flat-panel displays, and more particularly, to an oven and an adjustable baking system.

2. Description of the Prior Art

Nowadays, a baking device used for baking a glass substrate in a production line for manufacturing a flat-panel device. The glass substrate is required in the process of soft bake and hard bake. Currently, the baking time is fixed in any device having functions of soft bake and hard bake in the process of manufacturing a flat-panel device. That is, a baked glass substrate will be taken out of the oven soon after the baking time set for the oven is up. At this time, the baking process is done.

For example, conventionally, a baked product will be taken out of the oven as soon as possible in the production line of a flat-panel display. So, a product in the developing apparatus in the previous production process cannot be taken out of the developing apparatus in time.

Please refer to FIG. 1. There is a real buffer in the previous process of a conventional production line. The real buffer is used for receiving a glass substrate transferred by the developing apparatus in time so that the product can be taken out of the developing apparatus in the previous process in time without damage. The glass substrate comprises a color film. It takes a period of time to hard bake the color film for photoresist solidification. During the period of time, the glass substrate can still be baked a bit longer after the photoresist is completely solidified. The quality of the glass substrate is not affected.

Specifically, a sensor A at the exit of the developing apparatus shows an “On” signal and sends a “Send” signal to the next process oven once the glass substrate is at the exit of the developing apparatus in the previous process. The oven will send a “Receive” signal to the developing apparatus if no glass substrate is at the entrance of the oven. When the developing apparatus receives the “Receive” signal, the glass substrate starts to be transferred to the oven. However, the conventional oven is in a dilemma. A robot of the oven has begun to take the baked product out of the oven once the glass substrate finishes being transferred. At this time, the glass substrate waits at the entrance of the oven until the robot stopping moving the baked product. Meanwhile, the glass substrate in the developing apparatus is being moved into the real buffer.

As for the conventional technology where a real buffer is used, production cost is very high.

Moreover, the baking time of the oven in the conventional technology is inflexible. The ready-to-be-baked glass substrate transferred by the developing apparatus will be taken out of the real buffer only after the baking time is up, which implies low efficiency of baking These are the disadvantages of the conventional technology.

### SUMMARY OF THE INVENTION

An object of the present invention is to provide an oven comprising a virtual buffer and an adjustable baking system using the same for solving the problems occurring in the conventional technology.

According to the present invention, an oven comprises a signal receiving module, a baking module, a detecting module, and a feedback module. The signal receiving module is used for receiving a ready-to-send signal sent by a developing apparatus in a previous process. The ready-to-send signal conveys information of preparing for transferring a glass substrate. The baking module is used for baking the glass substrate. The detecting module is used for detecting a robot to see if the robot takes the glass substrate out of the baking module. The feedback module is used for determining if a confirmation signal is sent back to the developing apparatus according to a detecting result of the detecting module. The confirmation signal conveys information that the developing apparatus transfers the glass substrate to the feedback module.

In one aspect of the present invention, the feedback module sends back the confirmation signal to the developing apparatus once the detecting module ensures that the robot fails to take a baked glass substrate out of the baking module.

In another aspect of the present invention, the feedback module sends back the confirmation signal to the developing apparatus once the detecting module ensures that the robot has taken a baked glass substrate out of the baking module.

In still another aspect of the present invention, the detecting module detects the robot to see if the robot is taking a baked glass substrate out of the baking module, and the feedback module sends back the confirmation signal to the developing apparatus once the robot finishes taking out of the baked glass substrate.

According to the present invention, an adjustable baking system comprises a developing apparatus, an oven, and a robot. The developing apparatus comprises a sensor used for sensing a glass substrate. The sensor sends a ready-to-send signal to the oven when the sensor senses the glass substrate which is ready to be baked in the oven on the developing apparatus. The oven receives the ready-to-send signal, detects the robot to see if the robot is taking the glass substrate out of the oven, and determines if a confirmation signal is sent back to the developing apparatus based on a detecting result. The developing apparatus transfers the glass substrate to the oven once receiving the confirmation signal sent back by the oven.

In one aspect of the present invention, the oven sends back the confirmation signal to the developing apparatus once the oven ensures that the robot fails to take a baked glass substrate out of the oven. The robot takes the baked glass substrate out of the oven after the developing apparatus finishes transferring the glass substrate to the oven.

In another aspect of the present invention, the oven sends back the confirmation signal to the developing apparatus once the oven detects the robot and ensures that the robot has taken a baked glass substrate out of the oven. The developing apparatus transfers the glass substrate to the oven once receiving the confirmation signal sent back by the oven.

In still another aspect of the present invention, the oven detects the robot to ensure that the robot is taking the baked glass substrate out of the oven, and then the oven sends back the confirmation signal to the developing apparatus after the robot finishes taking the baked glass substrate out of the oven. The developing apparatus transfers the glass substrate to the oven once receiving the confirmation signal sent back by the oven.

In contrast to prior art, since the transfer speed of a ready-to-be-baked glass substrate transferred by a developing apparatus in a previous process can be adjusted in the oven and the adjustable baking system of the present invention, no buffers need to be used. Thus, equipment costs are reduced. In addition, the baking time of the oven is adjusted, which increases efficiency of baking

### BRIEF DESCRIPTION OF THE DRAWINGS

For better understanding embodiments of the present invention, the following detailed description taken in conjunction with the accompanying drawings is provided. Apparently, the accompanying drawings are merely for some of the embodiments of the present invention. Any ordinarily skilled person in the technical field of the present invention could still obtain other accompanying drawings without use laborious invention based on the present accompanying drawings.

FIG. 1 illustrates a schematic diagram of a conventional production line for manufacturing a flat display.

FIG. 2 is a structure diagram showing the adjustable baking system according to a first embodiment of the present invention.

FIG. 3 is a structure diagram showing the adjustable baking system according to a second embodiment of the present invention.

FIG. 4 is a structure diagram showing the oven according to the present invention.

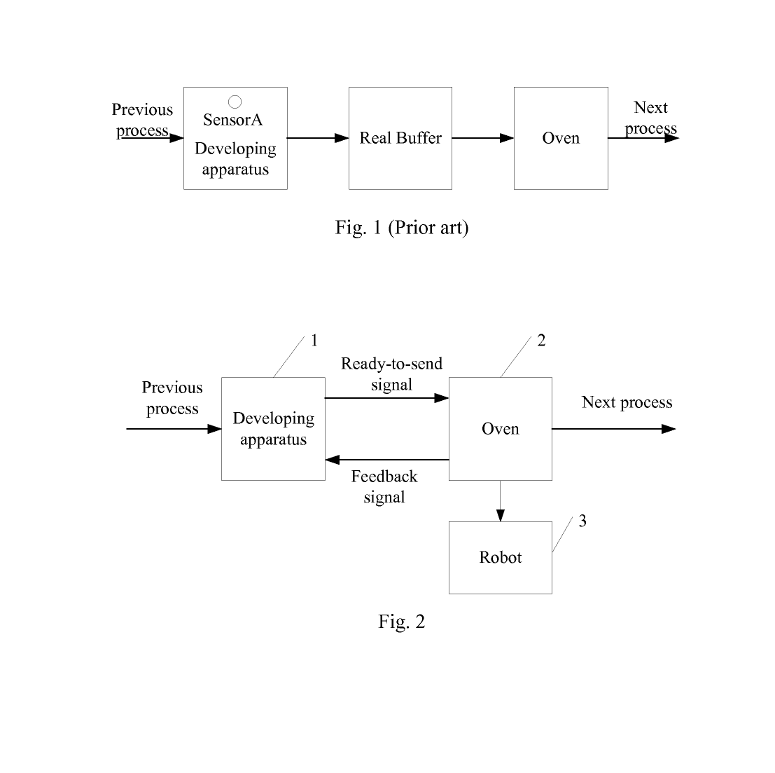

### DETAILED DESCRIPTION OF THE PREFERRED EMBODIMENTS

An adjustable baking system and an oven are provided in the present invention. The transfer speed of a ready-to-be-baked glass substrate can be adjusted in this system.

FIG. 2 is a structure diagram showing the adjustable baking system according to the present invention.

The adjustable baking system comprises a developing apparatus 1, an oven 2, and a robot 3.

The developing apparatus 1 comprises a sensor used for sensing a glass substrate. The sensor sends a ready-to-send signal to the oven 2 when the sensor senses a glass substrate which is ready to be baked in the oven 2 on the developing apparatus 1.

The oven 2 receives the ready-to-send signal, detects the robot 3 to see if the robot 3 takes out of the glass substrate, and then determines if a confirmation signal should be sent back to the developing apparatus 1 based on the detecting result.

The developing apparatus 1 receives the confirmation signal and transfers the ready-to-be-baked glass substrate to the oven 2.

Specifically, the first implementation method is described as follows.

The oven 2 sends back the confirmation signal to the developing apparatus 1 when the oven 2 discovers that the robot 3 does not take the baked glass substrate out of the oven.

Next, the developing apparatus 1 transfers another ready-to-be-baked glass substrate to the oven 2, and then the robot 3 takes the baked glass substrate out of the oven 2.

The second implementation method is described as follows.

The oven 2 sends back the confirmation signal to the developing apparatus 1 when the oven 2 ensures that the robot 3 has taken the baked glass substrate out of the oven.

Next, the developing apparatus 1 transfers another ready-to-be-baked glass substrate to the oven 2 upon receiving the confirmation signal sent back by the oven 2.

The third implementation method is described as follows.

The oven 2 discovers that the robot 3 is taking the baked glass substrate out of the oven 2. The oven 2 sends back the confirmation signal to the developing apparatus 1 after the baked glass substrate has been taken out.

The developing apparatus 1 transfers a ready-to-be-baked glass substrate to the oven 2 upon receiving the confirmation signal sent back by the oven 2.

In reality, as shown in FIG. 3, the adjustable oven system of the present invention provides the function of adjustable baking by improving hardware and software.

A sensor B is added at the entrance of the developing apparatus in the previous process in addition to the original sensor A. The developing apparatus sends a ready-to-send signal to the oven in the next process when the sensor B senses a ready-to-be-baked glass substrate placed on the developing apparatus. The ready-to-send signal notifies the oven that a glass substrate will be transferred by the developing apparatus soon. Meanwhile, a confirmation signal is added to the oven. The oven will send the confirmation signal to the developing apparatus when the oven discovers that the ready-to-send signal is “On” and that the robot does not move the baked glass substrate. At this time, the robot stops moving the baked product. The robot starts to take the baked glass substrate out of the oven when the developing apparatus finishes transferring the ready-to-be-baked glass substrate to the oven. The oven will send the confirmation signal to the developing apparatus after ensuring that the baked glass substrate has been taken out by the robot. Afterwards, the developing apparatus transfers another ready-to-be-baked glass substrate to the oven. The robot waits for the completion of transferring the ready-to-be-baked glass substrate.

In this embodiment, a sensor B is added to the developing apparatus in the previous process to detect the transfer condition of the glass substrate in time. Then, two communication signals, i.e. ready-to-send signal and confirmation signal, are added to move items at the entrance of the oven superiorly so that the baking time of the oven can be adjusted flexibly. It seems that a virtual buffer performs its function. Since no real buffers are used in the present invention, not only purchasing cost of a real buffer is saved but also no standstill of transfer occurs in the production line.

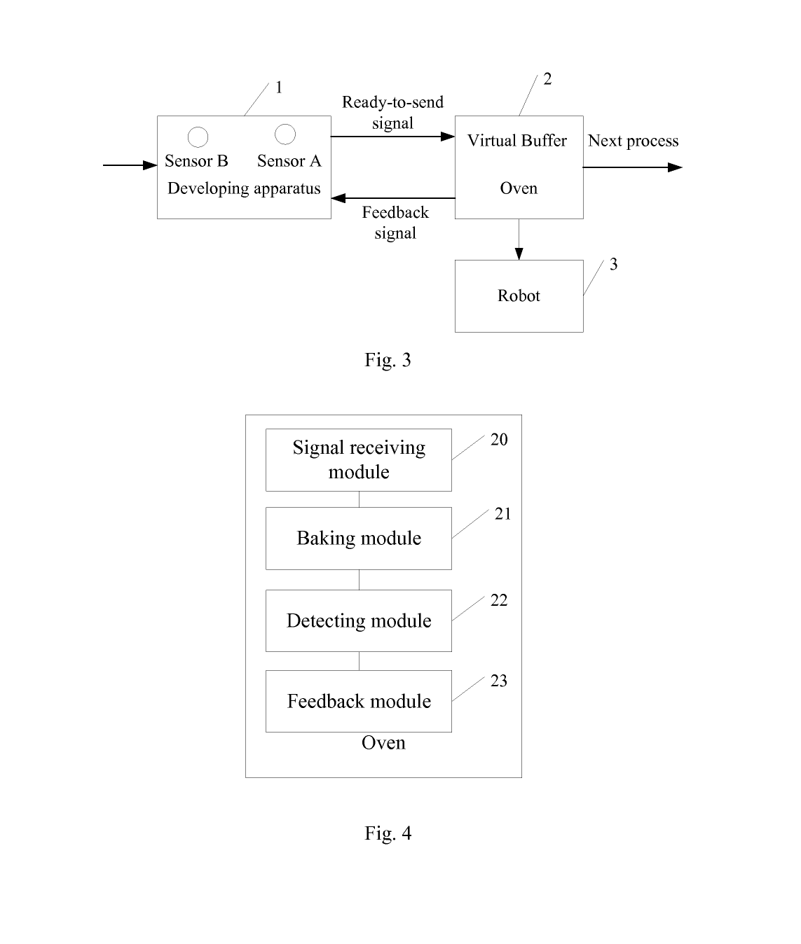

FIG. 4 is a structure diagram showing the oven according to the present invention.

The oven comprises a signal receiving module 20, a baking module 21, a detecting module 22, and a feedback module 23.

The signal receiving module 20 is used for receiving a ready-to-send signal issued by the developing apparatus 1 (as shown in FIG. 3) in the previous process from the oven 2. The ready-to-send signal conveys information of transferring a ready-to-be-baked glass substrate.

The baking module 21 is used for baking the glass substrate.

The detecting module 22 is used for detecting the robot 3 (as shown in FIG. 3) to see if the robot 3 takes the glass substrate out of the baking module 21.

The feedback module 23 is used for determining if a confirmation signal is sent back to the developing apparatus 1 according to the detecting result from the detecting module 22. The confirmation signal conveys information that the developing apparatus 1 should transfer a ready-to-be-baked glass substrate to the feedback module 23.

It is worth noting that the robot 3 can be an individual entity different from the oven 2, or can be one of the functions of the oven 2.

In the first method of implementation, the detecting module 22 detects the robot 3 and ensures that the robot 3 fails to take the baked glass substrate out of the baking module 21. Afterwards, the feedback module 23 sends back the confirmation signal to the developing apparatus 1.

In the second method of implementation, the detecting module 22 detects the robot 3 and ensures that the robot 3 completes the act of taking the baked glass substrate out of the baking module 21. Afterwards, the feedback module 23 sends back the confirmation signal to the developing apparatus 1.

In the third method of implementation, firstly, the detecting module 22 detects the robot 3 and ensures that the robot 3 is taking the baked glass substrate out of the baking module 21. Next, the robot 3 completes the act of taking out of the baked glass substrate. Finally, the feedback module 23 sends back the confirmation signal to the developing apparatus 1.

Since the transfer speed of a ready-to-be-baked glass substrate transferred by a developing apparatus in the previous process can be adjusted in the oven and the adjustable baking system of the present invention, no buffers need to be used. Thus, equipment costs are reduced. In addition, the baking time of the oven is adjusted, which increases efficiency of baking

Persons skilled in the art understand ordinarily that all or some of the processes in the above-mentioned embodiment can be implemented in related hardware through computer software code. The computer software code can be stored in a computer-readable medium. Each of the processes in the above-mentioned embodiment is included when the program works. The computer-readable medium can be a disk, a compact disk (CD), read-only memory (ROM), random access memory (RAM), and so on.

What is claimed is:

1. An oven, comprising:
a signal receiving module, for receiving a ready-to-send signal sent by a developing apparatus in a previous process, and the ready-to-send signal conveying information of preparing for transferring a glass substrate;
a baking module, for baking the glass substrate;
a detecting module, for detecting a robot to see if the robot takes the glass substrate out of the baking module;
a feedback module, for determining if a confirmation signal is sent back to the developing apparatus according to a detecting result of the detecting module, and the confirmation signal conveying information that the developing apparatus transfers the glass substrate to the feedback module.

2. The oven as claimed in claim 1, wherein the feedback module sends back the confirmation signal to the developing apparatus once the detecting module ensures that the robot fails to take a baked glass substrate out of the baking module.

3. The oven as claimed in claim 1, wherein the feedback module sends back the confirmation signal to the developing apparatus once the detecting module ensures that the robot has taken a baked glass substrate out of the baking module.

4. The oven as claimed in claim 1, wherein the detecting module detects the robot to see if the robot is taking a baked glass substrate out of the baking module, and the feedback module sends back the confirmation signal to the developing apparatus once the robot finishes taking out of the baked glass substrate.

5. An oven, comprising:
a signal receiving module, for receiving a ready-to-send signal sent by a developing apparatus in a previous process, and the ready-to-send signal conveying information of preparing for transferring a glass substrate;
a baking module, for baking the glass substrate;
a detecting module, for detecting a robot to see if the robot takes the glass substrate out of the baking module;
a feedback module, for determining if a confirmation signal is sent back to the developing apparatus according to a detecting result of the detecting module, and the confirmation signal conveying information that the developing apparatus transfers the glass substrate to the feedback module;
wherein the detecting module detects the robot to see if the robot is taking a baked glass substrate out of the baking module, and the feedback module sends back the confirmation signal to the developing apparatus once the robot finishes taking out of the baked glass substrate.

6. An adjustable baking system, comprising a developing apparatus, an oven, and a robot;
the developing apparatus comprising a sensor used for sensing a glass substrate, and the sensor sending a ready-to-send signal to the oven when the sensor senses the glass substrate which is ready to be baked in the oven on the developing apparatus;
the oven receiving the ready-to-send signal, detecting the robot to see if the robot is taking the glass substrate out of the oven, and determining if a confirmation signal is sent back to the developing apparatus based on a detecting result;
the developing apparatus transferring the glass substrate to the oven once receiving the confirmation signal sent back by the oven.

7. The adjustable baking system as claimed in claim 6, wherein the oven sends back the confirmation signal to the developing apparatus once the oven ensures that the robot fails to take a baked glass substrate out of the oven;
the robot takes the baked glass substrate out of the oven after the developing apparatus finishes transferring the glass substrate to the oven.

8. The adjustable baking system as claimed in claim 6, wherein the oven sends back the confirmation signal to the developing apparatus once the oven detects the robot and ensures that the robot has taken a baked glass substrate out of the oven;
the developing apparatus transferring the glass substrate to the oven once receiving the confirmation signal sent back by the oven.

9. The adjustable baking system as claimed in claim 6, wherein the oven detects the robot to ensure that the robot is taking the baked glass substrate out of the oven, and then the oven sends back the confirmation signal to the developing apparatus after the robot finishes taking the baked glass substrate out of the oven;
the developing apparatus transferring the glass substrate to the oven once receiving the confirmation signal sent back by the oven.
